(19) United States
(12) Patent Application Publication
(10) Pub. No.: US 2014/0119555 A1
(43) Pub. Date: May 1, 2014

(54) EARPHONE DEVICE HAVING INTEGRATED ANTENNA

(71) Applicant: DEXIN CORPORATION, NEW TAIPEI CITY (TW)

(72) Inventor: HO-LUNG LU, NEW TAIPEI CITY (TW)

(73) Assignee: DEXIN CORPORATION, NEW TAIPEI CITY (TW)

(21) Appl. No.: 13/663,582

(22) Filed: Oct. 30, 2012

(51) Int. Cl. H04R 1/10

(52) U.S. Cl. 381/74

(57) ABSTRACT

An earphone device having an integrated antenna, comprising a coaxial cable, a receiver and a signal processing module. The coaxial cable includes a first end and a second end. The receiver includes an antenna module and a speaker module, where the antenna module and the speaker module are in connection and are electrically connected to the first end of the coaxial cable. The signal processing module includes a baseband unit and a radio frequency unit, where the baseband unit and the radio frequency unit are in connection and are electrically connected to the second end of the coaxial cable. Thus, the earphone device having an integrated antenna of the instant disclosure can reduce the surface area of the main board effectively to enhance the efficiency of the antenna.

### BACKGROUND OF THE INSTANT DISCLOSURE

1. Field of the Instant Disclosure

The instant disclosure relates to an earphone device; in particular, to an earphone device having an integrated antenna.

2. Description of Related Art

In present day, consumer electronic products such as mobile phones, notebook computer and etc. are usually equipped with a wireless transmission function such as Bluetooth for users to listen to music or communicate more conveniently through a Bluetooth wireless earphone. Nevertheless, the antenna of a conventional Bluetooth wireless earphone is usually a coaxial cable or a chip antenna arranged on the main board of the earphone for wireless transmission. Thus, utilizing a coaxial cable described in the prior design is prone to reduce the efficiency of the antenna, where the later design may increases the surface area of the main board which in turn reduces the efficiency of the antenna.

Therefore, it is a critical issue for those who are skilled in the field to find a solution to enhance the efficiency of the antenna and reduce the surface area of the main board of the wireless earphone.

### SUMMARY OF THE INSTANT DISCLOSURE

The object of the instant disclosure is to provide an earphone device having integrated antenna, where a chip antenna of the instant disclosure can be placed within the user's ear to reduce the surface area of the main board so as to enhance the efficiency of the antenna.

An embodiment of the instant disclosure provides an earphone device having an integrated antenna, comprising a coaxial cable, a receiver, and a signal processing module. The coaxial cable includes a first end and a second end. The receiver includes an antenna module and a speaker module, where the antenna module and the speaker module are in connection and are electrically connected to the first end of the coaxial cable. The signal processing module includes a baseband unit and a radio frequency unit, where the baseband unit and the radio frequency unit are in connection and are electrically connected to the second end of the coaxial cable.

Another embodiment of the instant disclosure provides an earphone device having an integrated antenna, comprising a first coaxial cable, a second coaxial cable, a receiver unit and a signal processing module. The first coaxial cable includes a first end and a second end; similarly, the second coaxial cable includes a first end and a second end. The receiver unit includes a first receiver and a second receiver. The first receiver includes an antenna module and a speaker module, where the antenna module and the speaker module are in connection and are electrically connected to the first end of the first coaxial cable. The second receiver includes a speaker module connected electrically to the first end of the second coaxial cable. The signal processing module includes a baseband unit and a radio frequency unit, where the baseband unit and the radio frequency unit are in connection and are electrically connected to the second end of the first coaxial cable and the second end of the second coaxial cable.

Based on the above, the instant disclosure provides an earphone device having an integrated antenna, where the earphone device can reduce the surface area of the main board effectively so as to enhance the efficiency of the antenna through “the antenna module and the speaker module are in connection and are electrically connected to the first end of the coaxial cable”, and “the baseband unit and the radio frequency unit are in connection and are electrically connected to the second end of the coaxial cable”.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a block diagram of an earphone device integrated with an antenna according to a first embodiment of the instant disclosure;

FIG. 2 shows a perspective view of a coaxial cable of the earphone device integrated with an antenna according to the first embodiment of the instant disclosure;

FIG. 3 shows a three-dimensional perspective view of the earphone device integrated with an antenna according to the first embodiment of the instant disclosure;

FIG. 4 shows a block diagram of the earphone device integrated with an antenna according to a second embodiment of the instant disclosure;

FIG. 5 shows a perspective view of a first coaxial cable of the earphone device integrated with an antenna according to the second embodiment of the instant disclosure;

FIG. 6 shows a perspective view of a second coaxial cable of the earphone device integrated with an antenna according to the second embodiment of the instant disclosure;

FIG. 7 shows a three-dimensional perspective view of the earphone device integrated with an antenna according to the second embodiment of the instant disclosure.

### DETAILED DESCRIPTION OF THE PREFERRED EMBODIMENTS

### The First Embodiment

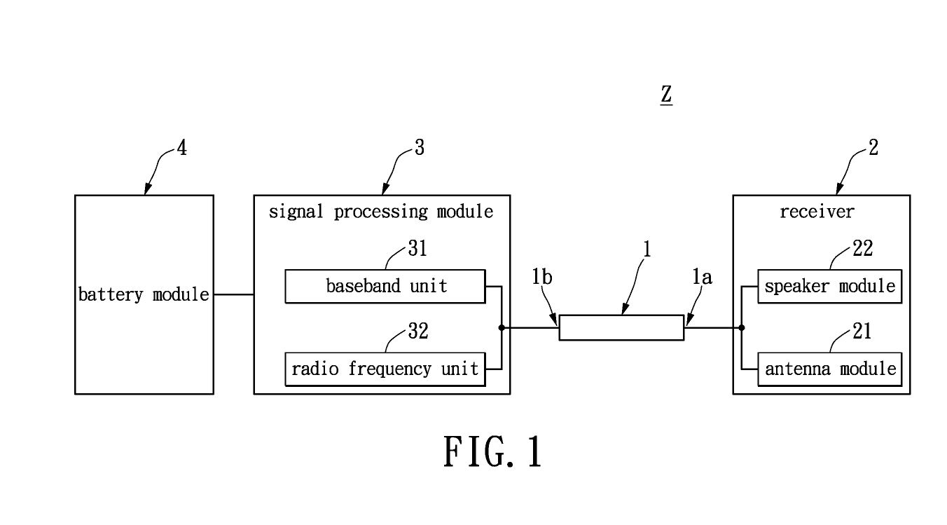

Please refer to FIGS. 1 to 3. According to the aforementioned figures, the instant embodiment provides an earphone device having an integrated antenna Z, comprising a coaxial cable 1, a receiver 2 and a signal processing module 3. Practically, the receiver 2 can be an earplug receiver. During utilization, the receiver 2 can be inserted into the user's ear for listening.

Shown in FIG. 1, the coaxial cable 1 has a first end 1a and a second end 1b. The receiver 2 includes an antenna module 21 and a speaker module 22, where the antenna module 21 and the speaker module 22 are in connection and are electrically connected to the first end 1a of the coaxial cable 1. To provide further explanations, as the speaker module 22 is placed proximate to the user's ear (not shown), where the antenna module 21 is placed away from the user's ear, where the antenna module is placed away from the user's ear and a predetermined distance (not shown) is kept from the receiver 2. Therefore, the antenna module 21 will not be easily influenced by the surrounding objects (such as the user's face) which may reduce the efficiency of the antenna. Hence, the earphone device having an integrated antenna Z of the instant disclosure can reduce the surface area of the main board effectively and enhance the efficiency of the antenna. Practically, the antenna module 21 can be a chip antenna such as a ceramic chip antenna having an operating frequency section of 2.4 GHz, where the speaker module 22 can be an amplifier such as a speaker to pronounce sound.

The signal processing module 3 includes a baseband unit 3131 and a radio frequency unit 32, where the baseband unit 3131 and the radio frequency unit 32 are in connection and are connected electrically to the second end lb of the baseband unit 3131. To provide further explanations, the baseband signal of the baseband unit 3131 and the radio frequency signal of the radio frequency unit 32 are mixed together by the signal processing module 3 (main board) of the coaxial cable 1 to transmit and receive signals. Therefore, no additional base plate is required (mix circuit and filter circuit) to mix the radio frequency signal and the baseband signal. Furthermore, the baseband signal can utilize the differential signal during transmission, and thereby, no additional base plate is required to reduce noise. Practically, the aforementioned baseband unit 31 can be a chip utilized to process low frequency signals (such as sound signals having frequency lower than 20 KHz), where the radio frequency unit 32 can be a chip utilized to process high frequency signals (such as a working frequency section of 2.4 GHz).

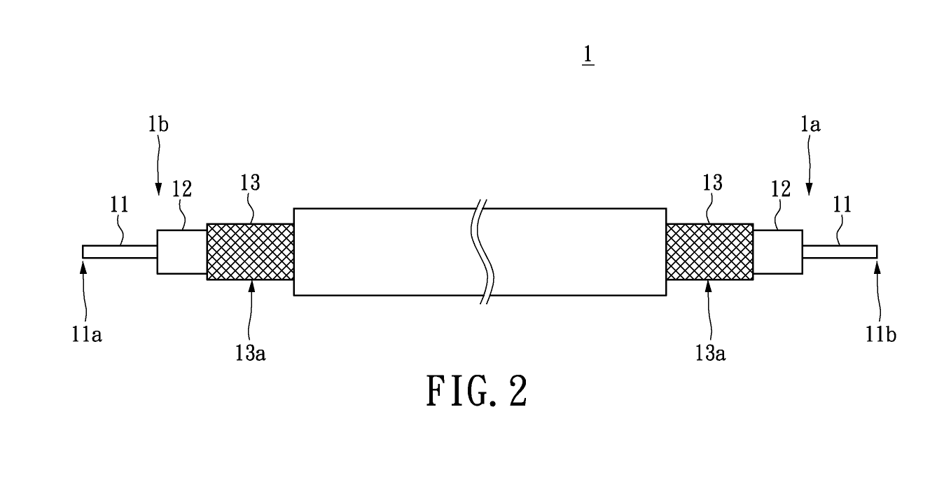

Shown in FIG. 2, the coaxial cable 1 includes a central rod 11, an insulative portion 12 sheathing the central rod 11, and an outer conductive portion 13 sheathing the insulative portion 12. The two ends of the central rod 11 are formed with a feed-in end 11a and a signal end 11b, and the outer conductive portion 13 has a ground end 13a. To provide further explanations, the feed-in end 11a of the central rod 11 is arranged proximate to the signal processing module 3, and the signal end 11b of the central rod 11 is arranged proximate to the receiver 2. Furthermore, the central rod 11 is utilized to transmit baseband signal and radio frequency signal. The outer conductive portion 13 can be a reference ground for the baseband signal and the radio frequency signal. Practically, the coaxial cable 1 can be a coaxial wire

Please refer to FIG. 1, the earphone device having an integrated antenna Z of the instant disclosure further includes a battery module 4 electrically connected to the signal processing module 3. Practically, the battery module 4 can utilize a rechargeable battery as a power saving device to provide electricity to the signal processing module 3.

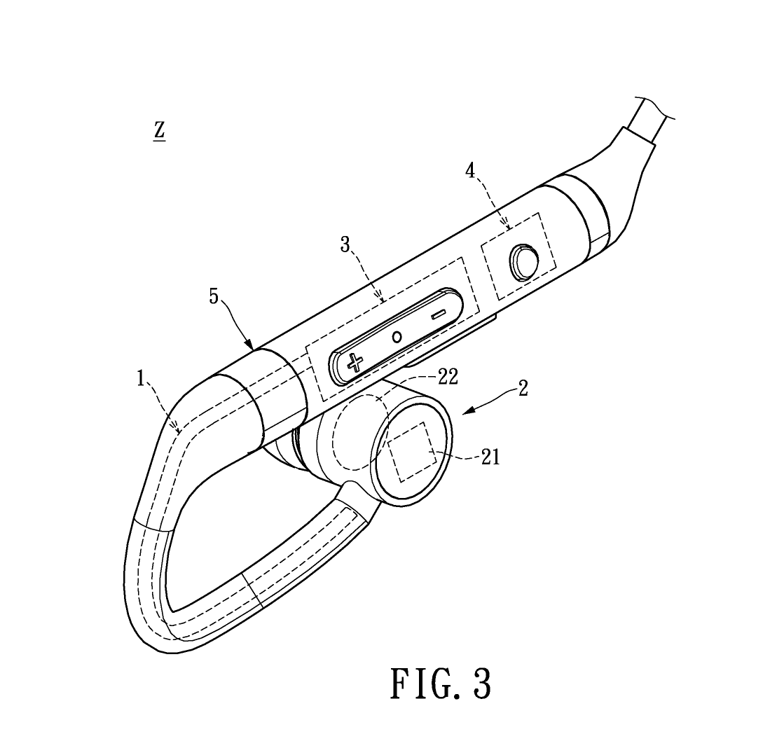

Please refer to FIG. 3, the earphone device having an integrated antenna Z of the instant disclosure further includes a housing 5, where the coaxial cable 1, the receiver 2, the signal processing module 3 and the battery module 4 can be received within the housing 5. It is worth noting that the components accommodated within the housing 5 can be adjusted or switched according to practical needs.

### The Second Embodiment

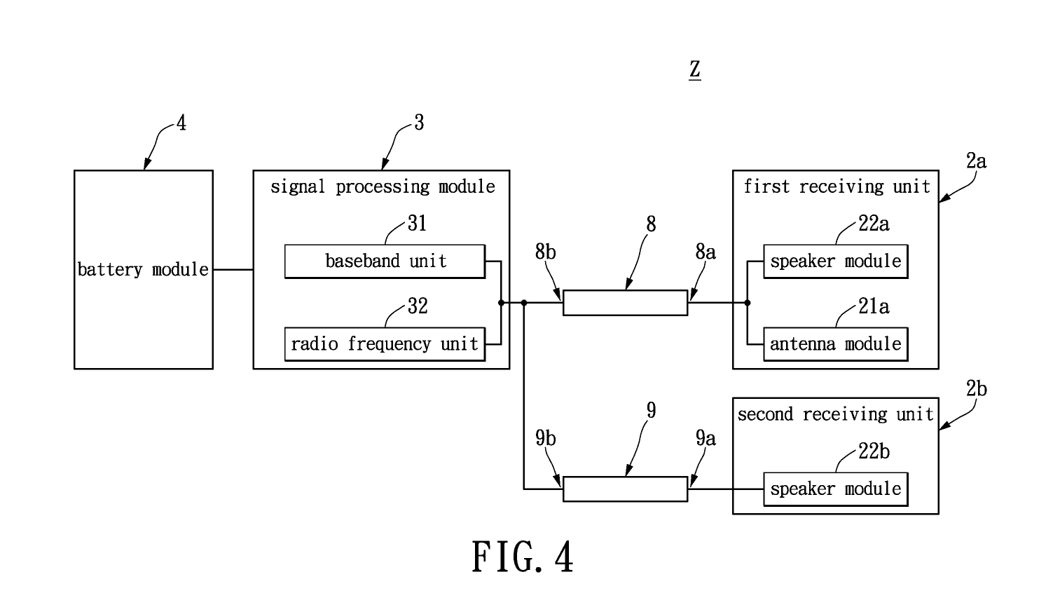

Please refer to FIGS. 4 to 7. The second embodiment of the instant disclosure provides an earphone device having an integrated antenna Z, comprising a first coaxial cable 8, a second coaxial cable 9, a receiver unit (which comprises a pair of receivers 2a/b), and a signal processing module 3.

By comparing FIG. 4 to FIG. 1, the difference between the second embodiment and the prior embodiment is that the first coaxial cable 8 of the second embodiment includes a first end 8a and a second end 8b, and the second coaxial cable 9 includes a first end 9a and a second end 9b. Furthermore, the receiver unit includes a first receiver 2a and a second receiver 2b, where the first receiver 2a includes an antenna module 21a and a speaker module 22a, while the antenna module 21a and the speaker module 22a are structurally and electrically connected at the first end 8a of the first coaxial cable 8. The second receiver 2b includes a speaker module 22b connected electrically to the first end 9a of the second coaxial cable 9. The signal processing module 3 includes a baseband unit 31 and a radio frequency unit 32, where the baseband unit 31 and the radio frequency unit 32 are in connection and are electrically connected to the second end 8b of the first coaxial cable 8 and the second end 9b of the second coaxial cable 9.

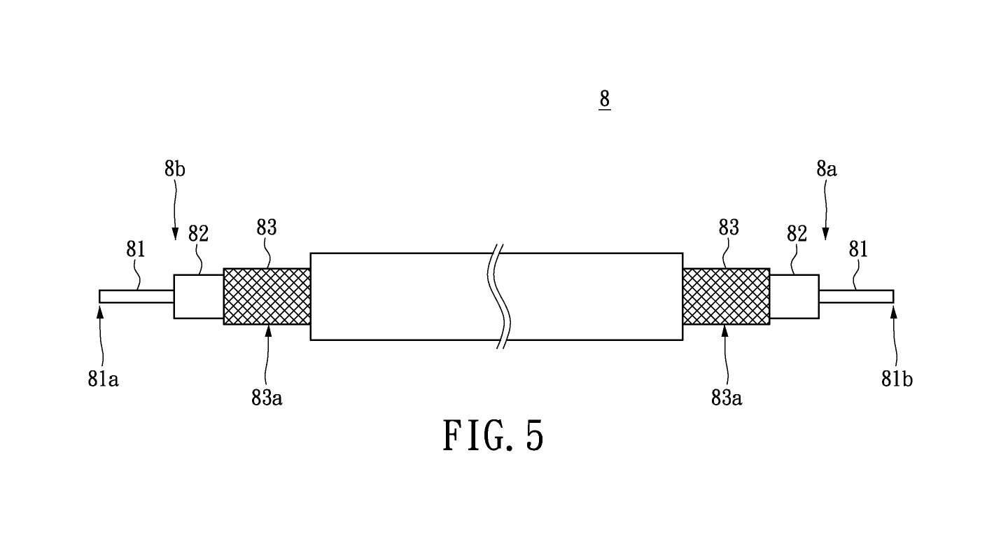

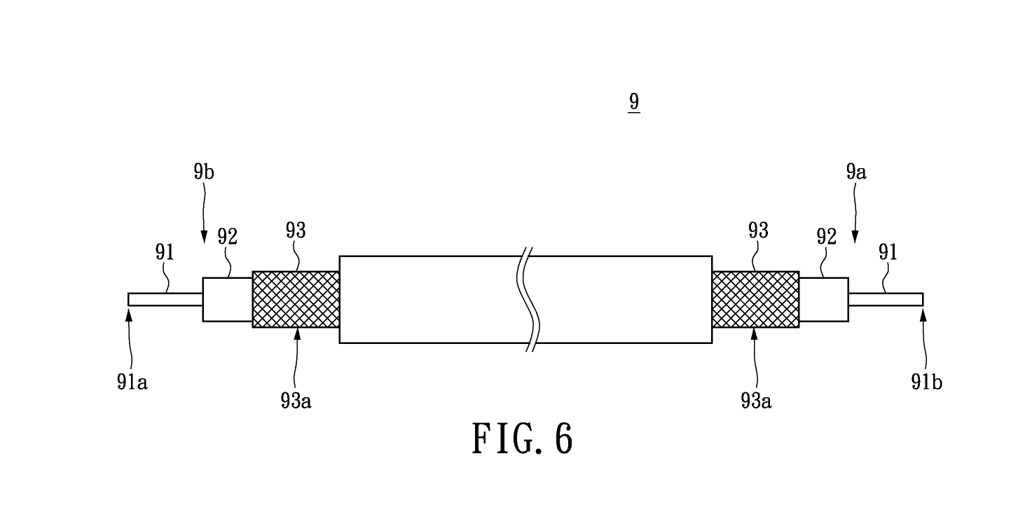

Shown in FIG. 5, the first coaxial cable 8 includes a central rod 81, an insulative portion 82 sheathing the central rod 81, and an outer conductive portion 83 sheathing the insulative portion 82. The two sides of the central rod 81 are formed with a feed-in end 81a and a signal end 81b, where the outer conductive portion 83 has a ground end 83a. Shown in FIG. 6, the second coaxial cable 9 includes a central rod 91, an insulative portion 92 sheathing the central rod 91 and an outer conductive portion 93 sheathing the insulative portion 92. The two sides of the central rod 91 are formed with a feed-in end 91a and a signal end 91b, where the outer conductive portion 93 has a ground end 93a.

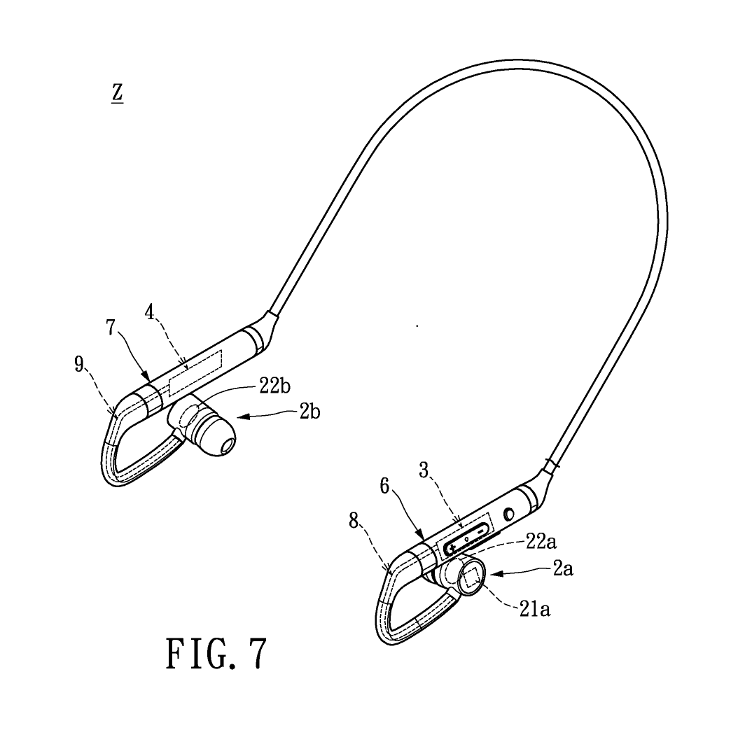

Shown in FIG. 4, the earphone device having an integrated antenna Z of the instant disclosure further includes a battery module 4 connected electrically to the signal processing module 3. Shown in FIG. 7, the earphone device having an integrated antenna Z of the instant disclosure further includes a first housing member 6 and a second housing member 7, where the first coaxial cable 8, the first receiver 2a, and the signal processing module 3 can be accommodated within the first housing member 6, and where the second coaxial cable 9, the second receiver 2b, and the battery module 4 can be accommodated within the second housing member 7. Furthermore, the first receiver 2a can be placed within the user's left ear, while the second receiver 2b can be placed within the user's right ear while in use. Thus, the instant disclosure can provide users with a stereophonic effect. It is worth noting that the components accommodated within the first housing member 6 and the second housing member 7 can be adjusted or switched due to practical needs.

[Possible Effects of the Instant Disclosure]

Based on the above, the instant disclosure provides an earphone device having an integrated antenna, where the earphone device can reduce the surface area of the main board effectively so as to enhance the efficiency of the antenna through “the antenna module and the speaker module are in connection and are electrically connected to the first end of the coaxial cable”, and “the baseband unit and the radio frequency unit are in connection and are electrically connected to the second end of the coaxial cable”.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An earphone device having an integrated antenna, comprising:
a coaxial cable having a first end and a second end;
a receiver including an antenna module and a speaker module, wherein the antenna module and the speaker module are structurally and electrically arranged at the first end of the coaxial cable;
a signal processing module including a baseband unit and a radio frequency unit, wherein the baseband unit and the radio frequency unit are structurally and electrically arranged at the second end of the coaxial cable.

2. The earphone device having an integrated antenna according to claim 1, wherein the coaxial cable includes a central rod, an insulative portion sheathing the central rod, and an outer conductive portion sheathing the insulative portion, wherein the central rod has a feed-in end and a signal end formed on the two ends thereof, and wherein the outer conducive portion has a ground end.

3. The earphone device having an integrated antenna according to claim 1, further comprising a battery module electrically connected to the signal processing module.

4. The earphone device having an integrated antenna according to claim 3, further comprising a housing, wherein the coaxial cable, the receiver, the signal processing module, and the battery module are received in the housing.

5. An earphone device having an integrated antenna, comprising:
a first coaxial cable having a first end and a second end;
a second coaxial cable having a first end and a second end;
a receiver unit including a first receiver and a second receiver, wherein the first receiver includes an antenna module and a speaker module, wherein the antenna module and the speaker module are in connection and are electrically connected to the first end of the first coaxial cable, wherein the second receiver includes a speaker module, and wherein the speaker module is electrically connected to the first end of the second coaxial cable; and
a signal processing module including a baseband unit and a radio frequency unit, wherein the baseband unit and the radio frequency unit are in connection and are electrically connected to the second end of the first coaxial cable, and the second end of the second coaxial cable.

6. The earphone device having an integrated antenna according to claim 5, wherein the first coaxial cable includes a central rod, an insulative portion sheathing the central rod and an outer conductive portion sheathing the insulative portion, wherein the central rod has a feed-in end and a signal end formed on the two ends thereof, and wherein the outer conducive portion has a ground end; the second coaxial cable includes a central rod, an insulative portion sheathing the central rod, and an outer conductive portion sheathing the insulative portion, wherein the central rod has a feed-in end and a signal end formed on the two ends thereof, and wherein the outer conductive portion has a ground end.

7. The earphone device having an integrated antenna according to claim 5, further comprising a battery module electrically connected to the signal processing module.

8. The earphone device having integrated antenna according to claim 5, further comprising a first housing member, wherein the first coaxial cable, the first receiver, and the signal processing module are received in the first housing member.

9. The earphone device having integrated antenna according to claim 7, further comprising a second housing member, wherein the second coaxial cable, the second receiver, and the battery module are received in the second housing member.
